(19) United States
(12) Patent Application Publication
(10) Pub. No.: US 2014/0275330 A1
(43) Pub. Date: Sep. 18, 2014

(54) DUAL PURPOSE COATING

(71) Applicant: DEFLECTO, LLC, Indianapolis, IN (US)

(72) Inventors: Craig Malmloff, Fishers, IN (US); Patrick Jon Foley, Fishers, IN (US); Joseph C. Regula, Broadview Heights, OH (US); Robert Rafter, Dover, OH (US)

(73) Assignee: DEFLECTO, LLC, Indianapolis, IN (US)

(21) Appl. No.: 14/017,086

(22) Filed: Sep. 3, 2013

Related U.S. Application Data
(60) Provisional application No. 61/799,458, filed on Mar. 15, 2013.

(51) Int. Cl. C09D 5/00

(52) U.S. Cl. CPC C09D 5/00
USPC 523/149

(57) ABSTRACT

A protective floor covering or desk pad comprising a body having an upper and lower planar surface and a copolymer resin coating on the lower planar surface.

The present invention claims priority to U.S. Provisional Application No. 61/799,458 filed on Mar. 15, 2013, the entirety of which is also incorporated herein by reference to the extent permitted by law. The present invention is directed to a rubber based compound coating with one or more additives that allow the coating to bond to a surface and vary the coefficient of friction of the coating. The coating is applied to a surface of a protective covering and allowed to cure. The resulting protective covering can be used on multiple surfaces with out worry of damage to the surface or worry of movement of protective covering with use.

### FIELD OF THE INVENTION

### Background of the Invention

Protective mats for protecting flooring material from damage and wear are well known. Generally, protective mats consist of a flat panel made of a material that is suitable to prevent wear and tear on the underlying flooring material. In some instances, the protective mat may include studs or short spikes on the underside of the flat panel to hold the protective mat firmly in place on a textured flooring material such as carpeting. While protective mats with short spikes to prevent the protective mat from sliding or moving and improve the placement of a protective mat on textured flooring material, they are not always suitable for use with relatively smooth flooring materials like wood or tiled floor.

Generally, protective mats with a smooth, non-studded bottom surface are used for smooth flooring like tile or hardwood. These flooring protection mats may have a non-slip coating on the bottom surface of the mat. However, these non-slip coatings are only effective on smooth surface flooring and do not prevent the flooring protection mat from slipping on textured floorings such as carpet and even lower pile carpets like commercial grade carpet.

Some attempts to provide a protective mat that is suitable for both smooth and textured surfaces have been made. For example, some protective mats employ felt backing and recessed studs to accommodate both a textured surface and a smooth surface. However it has been found that the felt backing and recessed studs do not prevent the flooring protection mat from moving or slipping on textured surfaces like medium pile carpet and commercial grade carpet. Accordingly, there is a need for a convertible protective mat that provides a protective barrier by covering an underlying surface regardless of its surface material and texture.

### SUMMARY OF THE INVENTION

The present general inventive concept relates to a convertible protective floor covering or convertible floor mat with a coating on the underside of the protective floor covering. The coating on the underside of the protective floor covering serves as a friction device that is particularly ideal for use on both smooth and non-smooth or textured surfaces, including hard floor, commercial pile, low pile, and medium pile carpet.

Many coatings were investigated for this purpose ranging from tacky adhesives to rubberized films. A rubberized film such as neoprene, natural latex, styrene butadiene latex was preferred as it does not interact with the surface of the protective floor covering, or flooring surface, which prevents the film from sticking to the surface or allowing dirt or carpet fibers to adhere to the mat. Additives such as tackfiers, plasticizers, and the like are added to the copolymer resin or rubberized film to increase the coefficient of friction of the coating and improve other coating characteristics. The resulting mixture is applied to the surface of a protective floor covering with mechanical spray guns or a roller transfer system and allowed to cure for a time or dwell and at a temperature to remove all water from film in order to form a film or coating on the protective floor covering. These times and temperatures are well known to those of ordinary skill in the art. As a result of the film or coating, the protective floor covering can be used on multiple surfaces with out worry of damage to the surface from studs or worry of movement of the protective floor covering with use.

One embodiment of the invention includes a method of making a coating for a surface of a protective floor covering including a copolymer resin.

In another embodiment, the rubberized copolymer comprises at least one of copolymer resin selected from the group consisting of vinyl acrylic, vinyl acetate ethylene, polyureathane dispersions, styrene butadiene latex, styrene butadiene latex, neoprene latex, and natural rubber latex.

In another embodiment a catalyst is blended or added to copolymer resin.

In another embodiment a plasticizer is blended or added to the copolymer resin.

In another embodiment a tacktifer is blended or added to the copolymer resin.

In another embodiment, the copolymer resin contains rubber in a wt % amount between 1-20%.

In another embodiment, the copolymer resin contains rubber in a wt % amount between 75-95%.

In another embodiment, the copolymer resin has a static coefficient of friction is from 1.0 to 1.10.

In another embodiment of the invention a protective floor covering includes a body having an upper and lower planar surface and a copolymer resin coating on the lower planar surface.

In another embodiment, the copolymer resin coating includes at least one of copolymer resin selected from the group consisting of vinyl acrylic, vinyl acetate ethylene, polyureathane dispersions, styrene butadiene latex, styrene butadiene latex, neoprene latex, and natural rubber latex.

In another embodiment the copolymer resin protective coating includes a catalyst.

In another embodiment the copolymer resin protective coating includes a plasticizer.

In another embodiment the copolymer resin protective coating includes a tacktifer.

In another embodiment the copolymer resin protective coating is in a wt % amount between 1-20%.

In another embodiment the copolymer resin protective coating contains rubber is in a wt % amount between 75-95%.

In another embodiment the copolymer resin protective coating contains a static coefficient of friction is from 1.0 to 1.10.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts the protective floor covering with a coating being placed on a carpet.

FIG. 2 depicts a portion of a protective floor covering with the coating.

FIG. 3 depicts the protective floor covering with a coating being placed on a hard surface.

### DETAILED DESCRIPTION OF THE INVENTION

In accordance with the embodiments of the present invention, the present coating relates to protective floor coverings, and more particularly to protective floor coverings that are suitable on smooth and or textured surfaces.

The protective floor covering as shown in FIG. 1 includes a body 10 having upper and lower planar surfaces 12, 14, that are parallel to each other and are spaced from each other by an outermost perimeter edge 16 that extends entirely about the body 10. The coating is 18 is applied to the underside of the lower planar surface. The body 10 can be placed on a carpet 232 as a protective floor covering.

FIG. 2 depicts the protective floor covering that includes a body 10 having upper and lower planar surfaces 12, 14, that are parallel to each other and are spaced from each other by an outermost perimeter edge 16 that extends entirely about the body 10. The coating is 18 is applied to the underside of the lower planar surface 14. The planar surfaces can be smooth, relatively smooth or include various textures well known to those of ordinary skill in the art such as multiple planar surfaces, grooves, ribbing or dimples. The body 10 is of a generally uniform thickness and may be made of a material such as, but not limited to rubber, plastic, and/or the like, that is sufficiently durable to withstand wear and/or tear depending on and during use of for example the support of a chair on the upper surface 12 or lower surface 14 of the body 10. The body 10 may be made of a material that is transparent, translucent, opaque, and/or a combination thereof. The body 10 may have a pattern, for instance, on the lower surface 14 of the body, to form a design thereon. The body 10 may be made of a material that is transparent, translucent, opaque, and/or a combination thereof. The protective coating 16 can be applied to the lower planar surface 14 of the body.

The protective floor covering as shown in FIG. 3 includes a body 10 having upper and lower planar surfaces 12, 14, that are parallel to each other and are spaced from each other by an outermost perimeter edge 16 that extends entirely about the body 10. The coating is 18 is applied to the underside of the lower planar surface. The body 10 can be placed on a smooth surface 234 as a protective floor covering.

In general, the coating has a formulation comprising a polymer with a wide range of film formation temperatures and an amount of rubber sufficient to form a copolymer resin with sufficient polyvinyl chloride to provide a high coefficient of friction without causing the resulting copolymer resin to be pressure sensitive.

In an embodiment, the copolymer resin comprises at least one of vinyl acrylic, vinyl acetate ethylene and, polyureathane dispersions and styrene butadiene latex, styrene butadiene latex, neoprene latex, natural rubber latex. The copolymer resin can also comprise a combination of any vinyl acrylic, vinyl acetate ethylene, polyureathane dispersions, styrene butadiene latex, styrene butadiene latex, neoprene latex, and natural rubber latex and derivatives thereof.

In various embodiments the copolymer resin is in a wt % amount between 1-20%.

In various embodiments the copolymer resin contains rubber is in a wt % amount between 75-95%.

The copolymer resin is provided on a surface to impart frictional resistance between the protective floor covering and the underlying surface. The frictional resistance may be quantified by the static coefficient of friction of the copolymer resin. In order to provide frictional resistance between the protective floor covering and the underlying surface, the static coefficient of friction should be higher than static coefficient of friction of the underlying surface. In specific embodiments, the static coefficient of friction may be not tested and could be a pressure sensitive with no slip at any angle A preferred range of static coefficient of friction is from 1.0 to 1.10 not tested >1.1>psa qualities <1.0<anti skid and harder film more slip.

The copolymer resin can also contain other additives to improve overall characteristics of the coating. For example, any plasticizer known to those of ordinary skill in the art can be added in order to soften the coating. Some examples of suitable plasticizers include benzoflex 50, DBP can be used and pigments could be used for colouring.

The copolymer resin can also include a catalyst. The catalyst can be added to control the rates of polymerization and other reactions occurring within the copolymer resin. Suitable catalysts known to those of ordinary skill in the art can also be used to increase adhesion to PVC and lower coefficient of friction of the coating.

The method for applying the copolymer resin to the lower surface of the body is described below. The copolymer resin is applied to the lower surface of the body with mechanical spray guns or a roller transfer system. The copolymer resin is cured at or near room temperature or higher over 24 hours in order to form a film or coating on lower surface of the body. The coating is not limited to the underside surface of a protective floor matting, it can be applied to other protective coverings, or surfaces where an anti-slip function is needed, for example desk mats, mouse pads, place mats, drink coasters, desk storage containers or the like.

The amount of the copolymer resin coated onto the lower surface of the body will vary depending on the desired application. For example, where a higher friction, non-slip property of the coating is needed, a greater amount of the copolymer resin is applied to the lower surface. If a lower friction, non-slip property of the coating is needed, a lesser amount of the copolymer resin is applied to the lower surface. Generally, the amount of copolymer resin applied to the lower surface of the body is such that the friction provided by the coating permits the protective floor covering to be used on a generally smooth surface, e.g., hardwood, tile, slate, linoleum, concrete, and/or the like, and textured surfaces like low pile, medium pile, and commercial grade carpeting without the use of suds or spikes. In this manner, the user can avoid damaging the smooth surface and/or textured surface with only one protective floor covering.

To further illustrate various illustrative embodiments of the present inventions, the coating can be made of vinyl acrylic, vinyl acetate ethylene, and styrene butadiene latex, combinations or derivatives thereof.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A method of making a coating for a surface of a protective covering comprising:
a copolymer resin.

2. The method according to claim 1 wherein the rubberized copolymer comprises at least one of copolymer resin selected from the group consisting of vinyl acrylic, vinyl acetate ethylene, polyureathane dispersions, styrene butadiene latex, styrene butadiene latex, neoprene latex, and natural rubber latex.

3. The method according to claim 1 further comprising adding or blending a catalyst to the copolymer resin.

4. The method according to claim 1 further comprising adding or blending a plasticizer to the copolymer rein.

5. The method according to claim 2 further comprising adding a tacktifer

6. The method according to claim 1 wherein the copolymer resin is in a wt % amount between 1-20%.

7. The method according to claim 1 wherein the copolymer resin contains rubber in a wt % amount between 75-95%.

8. The method according to claim 1 wherein the copolymer resin has a static coefficient of friction is from 1.0 to 1.10.

9. A protective floor covering or desk pad comprising:
a body having an upper and lower planar surface;
a copolymer resin coating on the lower planar surface.

10. The copolymer resin protective coating according to claim 9 wherein the copolymer resin comprises at least one of copolymer resin selected from the group consisting of vinyl acrylic, vinyl acetate ethylene, polyureathane dispersions, styrene butadiene latex, styrene butadiene latex, neoprene latex, and natural rubber latex.

11. The copolymer resin protective coating according to claim 9 wherein the copolymer resin includes a catalyst.

12. The copolymer resin protective coating according to claim 9 wherein the copolymer resin includes a plasticizer.

13. The copolymer resin protective coating according to claim 9 wherein the copolymer resin includes a tacktifer.

14. The copolymer resin protective coating according to claim 9 wherein the copolymer resin is in a wt % amount between 1-20%.

15. The copolymer resin protective coating according to claim 9 wherein the copolymer resin contains rubber in a wt % amount between 75-95%.

16. The copolymer resin protective coating according to claim 9 wherein the copolymer resin has a static coefficient of friction is from 1.0 to 1.10.
